(19) United States
(12) Patent Application Publication
(10) Pub. No.: US 2004/0037024 A1
(43) Pub. Date: Feb. 26, 2004

(54) Optoelectronic package

(76) Inventors: Muhammad Arif, Allentown, PA (US); Hak K. Byun, Deer Park, NY (US)

Correspondence Address: Lester H. Birnbaum, 6308 Sauterne Drive, Macungie, PA, 18062, US

(21) Appl. No.: 10/463,255

(22) Filed: Jun. 17, 2003

Related U.S. Application Data
(60) Provisional application No. 60/399,475, filed on Jul. 29, 2002.

(51) Int. Cl. H02B 1/00

(52) U.S. Cl. 361/600

(57) ABSTRACT

A device package and method of fabrication where an optical fiber is aligned with an optical device, such as a laser or photodetector. An alignment assembly is provided which includes a ring and a barrel slidably mounted within an aperture in the ring. The ring is placed on a wall of the housing, and the barrel, which includes the fiber, is inserted in the ring. The barrel and/or the ring is moved until the desired position of the fiber is obtained, at which time the ring is fixed to the wall and to the barrel.

### CROSS REFERENCE TO RELATED APPLICATION

This application claims the benefit of co-pending provisional patent application No. 60/399,475 filed Jul. 29, 2002.

### FIELD OF THE INVENTION

The present invention relates generally to optoelectronics and, more particularly, to a package and method of fabricating an optoelectronic package with fiber receptacles.

### BACKGROUND OF THE INVENTION

Optical systems are now a key part of telecommunications, primarily due to their ability to transmit and receive enormous quantities of data. Such systems include an optical source, usually a laser, for generating optical signals, an optical detector for converting the light signals to electrical signals, and an optical fiber which transmits the signals between the source and detector. In bi-directional systems, the laser and photodetector are usually included in the same package as a transceiver or transponder. Other components include optical amplifiers and optical isolators.

In the fabrication of packages for these components, alignment of the fiber with the optical device in the package is critical for proper performance. Usually the device is mounted within a housing and the fiber is coupled through an aperture in a wall using standard connectors and receptacles, such as LC connectors. In most packages light is sent through the fiber while its position is changed until the desired signal strength is obtained (active alignment), at which time the position of the fiber is fixed, usually by welding. Unfortunately, in packages with fiber receptacles, such as uncooled laser packages, the fiber can only be manipulated in the x and y (horizontal and vertical) directions since the thickness of the fiber receptacle is fixed and, therefore, the distance of the fiber from the device (z direction) cannot easily be adjusted. This results in yield problems, and also necessitates different receptacles for different codes.

It is desirable, therefore, to provide a package and method of fabricating the package which permits easy alignment of the fiber receptacle in the z direction.

### SUMMARY OF THE INVENTION

The present invention in accordance with one aspect, provides a device package including a housing and an optical device mounted within the housing. The housing includes a wall and an aperture in the wall for transmitting light therethrough. Mounted to the wall is an assembly which includes a metal ring mounted to the wall and a metal barrel positioned within the ring.

In accordance with another aspect, the invention is a method of fabricating a device which includes a housing with a wall and aperture formed therethrough, and an optical device mounted within the housing. A ring is placed on the wall over the aperture. An optical fiber is inserted in a barrel, and the barrel is slidably mounted within the ring. The barrel is moved within the ring until a desired position of the fiber from the device is obtained. The barrel is fixed to the ring when the desired position is obtained.

In accordance with another aspect, the invention is a device package including a housing an optical device mounted within the housing, wherein the housing includes a wall and an aperture in the wall for transmitting light therethrough. The package includes means for aligning an optical fiber to the device including a metal ring mounted to the wall and a metal barrel positioned within the ring, wherein the fiber is mounted within the barrel.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice in the industry, the various features of the drawing are not to scale. On the contrary, the dimensions of the various features are arbitrarily expanded or reduced for clarity. Included in the drawing are the following figures:

The FIGURE is a cross sectional schematic exploded view of a device package in accordance with an embodiment of the invention.

### DETAILED DESCRIPTION OF THE INVENTION

Referring now to the drawing, wherein like reference numerals refer to like elements throughout, the FIGURE is a cross sectional, schematic, exploded view of a device package, 10, in accordance with an embodiment of the invention. The package includes a housing, 11, which is usually made of a metal such as Kovar. Typically, the housing also includes a lid, 12, which is secured to the base of the housing by a seam seal.

Mounted within the housing is an optical device, 13, which in this example is a standard semiconductor laser. The device could also be a photodetector, or any other optical device which needs alignment to a fiber. Further, the invention could be used for transceivers and transponders which employ both a laser and photodetector within the same housing. The laser is typically mounted to a submount, 14. The laser, 13, is electrically connected to circuitry (not shown) in the housing for driving the laser and performing other functions. The circuitry is usually coupled to the outside world by pins (not shown) which protrude from the housing.

The housing, 11, includes a wall, 15, having an aperture, 16, formed therethrough which permits light transmission between an optical fiber, 17, and the device, 13. The aperture, 16, may also include a lens (not shown) mounted therein. The light transmission may be incoming or outgoing according to the device, 13, employed.

An alignment assembly, 20, is utilized to actively align the fiber, 17, to the device, 13. The assembly includes a ring, 21, with an aperture, 22, formed therethrough. The ring is typically made of metal such as stainless steel. The front surface, 28, of the ring has a diameter such that the surface fits within a counter-sink, 18, formed in the wall, 15, in a manner which allows some movement of the ring relative to the wall. It should be understood that while this example includes the counter-sink, 18, it is not necessary for practicing the invention.

The assembly further includes a barrel, 23, which is slidably mounted in the aperture, 22, of the ring, 21. The barrel, 23, is a cylinder which can include beveled edges, 24 and 25. The barrel is typically made of metal which can be the same or different from the ring, 21. The outer diameter of the barrel is chosen so that the barrel can be slid in the Z-direction as indicated by the arrows. The inner diameter is chosen so that an optical connector, 30, mounted to the fiber, 17, can be inserted into the barrel and come to rest in contact with the front wall, 26, of the barrel so that the fiber is essentially immobile within the barrel. That is, the inner diameter of the barrel provides a tight fit for the connector, but the fiber and connector are usually rendered immobile within the barrel when a standard welding clamp (not shown) is applied to the barrel. The fiber may or may not protrude through the connector, 30, but in any event, the fiber will be stopped at the front wall, 26, since an aperture, 27, in the front wall typically has a smaller diameter than the diameter of the fiber. The connector, 30, can be a standard LC connector or any other type of fiber connector.

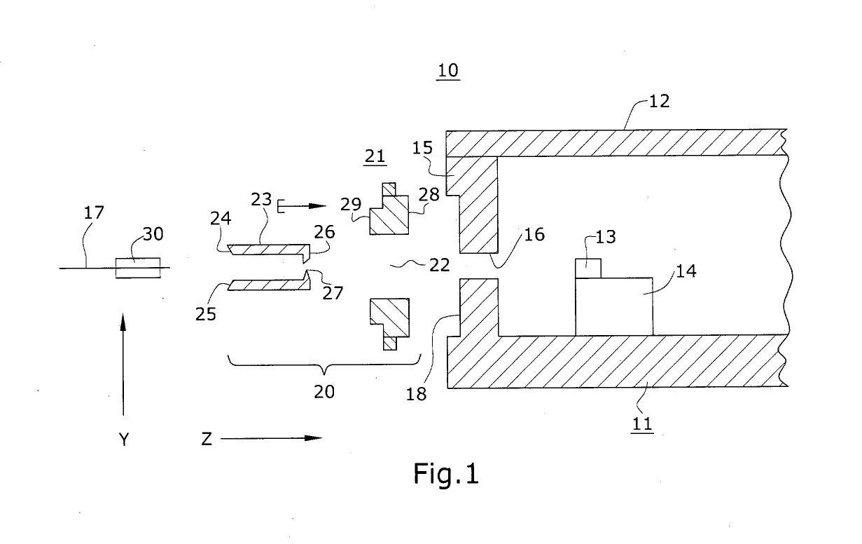

The device package, 10, in accordance with one embodiment, can be fabricated by orienting the housing at 90 degrees from that shown in FIG. 1 so that the wall, 15, is at the top. The ring, 21, can then be placed in the counter-sink, 18, in the wall, 15, so that the aperture, 22, in the ring is aligned with the aperture, 16, in the package wall. The fiber, 17 is inserted into the barrel, 23, until the connector, 30, contacts the front wall, 26, of the barrel, assuming the fiber does not protrude from the connector. The barrel, 23, and fiber, 17, are then clamped so that the position of the fiber is fixed relative to the barrel, 23.

The barrel, 23, is inserted into the aperture, 22, of the ring, 21 with a fit such that the barrel is free to slide in the Z-direction (toward and away from the device 13), but the barrel is essentially fixed in the x and y directions (horizontal and vertical directions in the view of the FIGURE) relative to the ring, 21. A drive current is applied to the laser, 13, in order to emit light from the laser into the fiber, 17, and the power of the light is monitored by standard means (not shown).

The fiber, 17, is precisely aligned with the laser, 13, typically by first moving the ring, 21, in the x and y directions until the desired light power from the fiber is obtained. The barrel, 23, is then moved through the ring, 21, in the z-direction until the desired power from the fiber is achieved. When alignment in the x, y, and z directions is achieved, the front surface, 28, of the ring is fixed to the wall, 15, of the housing, and the rear surface, 29, of the ring is fixed to the surface of the barrel, 23, so that the barrel is no longer free to slide within the ring. Preferably, all surfaces are made of metal so that the ring and barrel are fixed by welding, eg, standard laser welding. After welding, the fiber is essentially immobile in all directions so that proper alignment is maintained.

Thus, the assembly, 20, provides an easy and economical method of aligning the fiber in all three directions for any size package housing, 11. It will be understood that the same basic method could be used when the device, 13, is a photodetector by monitoring the electrical signal from the photodetector during the alignment process.

Although the invention has been described with reference to exemplary embodiments, it is not limited to those embodiments. Rather, the appended claims should be construed to include other variants and embodiments of the invention which may be made by those skilled in the art without departing from the true spirit and scope of the present invention.

What is claimed:

1. A device package comprising:
a housing; and
an optical device mounted within the housing,
wherein the housing includes a wall and an aperture in the wall for transmitting light therethrough,
the package comprising:
an assembly which includes a metal ring mounted to the wall; and
a metal barrel positioned within the ring.

2. The device package according to claim 1 wherein the device is a semiconductor laser.

3. The device according to claim 1 wherein the device is a semiconductor photodetector.

4. The device according to claim 1 wherein the metal ring is welded to the wall and to the barrel.

5. The device according to claim 1 wherein the wall includes a counter-sink in which the ring is mounted.

6. The device according to claim 1 further comprising an optical fiber mounted within the barrel.

7. The device according to claim 6 wherein the fiber includes a connector on a portion thereof which is mounted within the barrel.

8. The device according to claim 7 wherein the connector contacts a front wall of the barrel.

9. A method of fabricating a device package which includes a housing with a wall and a first aperture formed therethrough, and an optical device mounted within the housing, the method comprising:
placing a ring with a second aperture on the wall over the first aperture;
inserting an optical fiber in a barrel;
slidably mounting the barrel within the ring;
moving the barrel within the ring until a desired position of the fiber from the device is obtained; and
fixing the barrel to the ring when the desired position is obtained.

10. The method according to claim 9 wherein the ring is also moved over a surface of the wall until a desired position of the fiber is obtained, and the ring is then fixed to the wall.

11. The method according to claim 9 wherein the barrel is fixed to the ring by welding.

12. The method according to claim 9 wherein the position of the fiber is determined by sending light through the fiber while the barrel is moved within the ring.

13. The method according to claim 10 wherein the ring is fixed to the wall by welding.

14. The method according to claim 9 wherein the ring is placed in a counter-sink in the wall.

15. The method according to claim 9 wherein the fiber includes a connector, and the fiber is inserted in the barrel until the connector makes contact with a front wall of the barrel.

16. A device package comprising:
a housing; and
an optical device mounted within the housing,
wherein the housing includes a wall and an aperture in the wall for transmitting light therethrough,
the package comprising:
means for aligning an optical fiber to the device including a metal ring mounted to the wall; and
a metal barrel positioned within the ring,
wherein the fiber is mounted within the barrel.
